(19) United States
(12) Patent Application Publication
(10) Pub. No.: US 2025/0229964 A1
(43) Pub. Date: Jul. 17, 2025

(54) PACKAGED LAUNDRY PRODUCT

(71) Applicant: The Procter & Gamble Company, Cincinnati, OH (US)

(72) Inventors: Yanfang QU, Beijing (CN); Pu ZHAO, Beijing (CN); Xiaobin CHU, Beijing (CN); Rui SHEN, Beijing (CN); Kristin Rhedrick WILLIAMS, West Chester, OH (US)

(21) Appl. No.: 19/021,354

(22) Filed: Jan. 15, 2025

(30) Foreign Application Priority Data
Jan. 17, 2024 (WO) PCT/CN2024/072744

(51) Int. Cl. B65D 75/26; B65D 75/00; B65D 75/52; B65D 75/58; C11D 3/50; C11D 17/04

(52) U.S. Cl. CPC B65D 75/26; B65D 75/008; B65D 75/522; B65D 75/5883; C11D 3/505; C11D 17/041

(57) ABSTRACT

A packaged laundry product comprising a flexible package and a plurality of perfume-containing particles contained in the flexible package. Said packaged laundry product comprises perfume-containing particles which contains a carrier; and a perfume; and wherein each of said particles has a mass between 1 mg to 1 g, and has a maximum dimension of less than 10 mm. The flexible package is made of a layered film material and comprises a top end, an opposing bottom end, and two peripheral walls extending between the top end and the bottom end, wherein at least one or more parts of the flexible package is transparent or translucent. The flexible package is characterized that the bottom end of the flexible package comprises one or more holes.

### TECHNICAL FIELD

The present invention relates to packaged laundry products, especially perfume-containing particles in flexible packages.

### BACKGROUND

Scent is recognized to be a source of pleasure to consumers when they do their laundry. Consumers may associate certain scents with performance of the laundry products and as an indicator of quality of the laundry products. Laundry products that provide a pleasant or enhanced scent experience to the consumer when she dispenses the laundry product, transfers a load of wet laundry from the washer to the dryer or to a drying rack or line, or when she wears the clothing meet this consumer need.

Correspondingly, perfumed particles are becoming increasingly popular as a laundry scent additive. The perfumed particles can be used to impart new scent to, or enhance existing scent in, the articles being washed.

EP2661398A1 discloses a package comprising a bottle container containing a particulate laundry scent additive, which bottle container has a “squeeze and sniff” mechanism that can provide consumer scent attractions.

Flexible package (also called pouch) has been widely used as refill package to reduce bottle consumption as well as to save space in shipping/storage via easy pack. Flexible package can contain either liquid laundry detergent product or particulate detergent product, or solid laundry scent additive products (e.g., perfume-containing particles).

JP5225902B discloses a packaged softener that contains a perfumed softener composition, is excellent in the property of preventing leakage of a fragrance substance to the outside, and has excellent fragrance stability of the content.

JP6905333B discloses bag-shaped softener article in which discoloration of a bag-shaped container is suppressed by combining a specific polyol-based water-soluble solvent into the softener composition containing a phenol-based perfume component.

Today, many pouches look similar to each other, and it is hard to distinguish between laundry products (especially different form and/or function) in front of the shelf during shopping or during use at home. This is especially useful for consumers with limited visual acuity. Especially for the scent additive product, it would be more desirable and attractive to consumer if she can smell the scent of the product and choose her favorite.

Therefore, there is a need for a packaged perfumed particle product which is filled in a flexible package which can delight the consumer from prompt visual recognition as well as olfactory sensory.

### SUMMARY

The present disclosure provides a packaged laundry product comprising a flexible package and a plurality of perfume-containing particles contained in the flexible package, each of the perfume-containing particles comprises: a carrier; and a perfume; each of said particles has a mass between 1 mg to 1 g; and each of said particles has a maximum dimension of less than 10 mm, wherein the flexible package is made of a layered film material, and comprises a top end, an opposing bottom end, and two peripheral walls extending between the top end and the bottom end, wherein at least one or more parts of the flexible package is transparent or translucent, and the bottom end of the flexible package comprises one or more holes.

Preferably, the at least one or more parts of the walls of the flexible package is transparent, preferably the transparent part(s) has a light transmission rate of more than 60%.

Preferably, the transparent part is present in the front wall of the flexible package and is in the range of 5% to 95% of the total area of the front wall of the flexible package.

Preferably, each of the one or more holes has a maximum dimension of less than 2 mm, preferably less than 1 mm, more preferably less than 0.9 mm.

Preferably, the flexible package further comprises a solid spout located at or near the top end of the flexible package, preferably having a diameter ranging from 20 mm to 30 mm, more preferably ranging from 21 mm to 28 mm; wherein preferably said rigid spout is further characterized by a height ranging from 20 mm to 50 mm, preferably from 30 mm to 40 mm, more preferably from 32 mm to 38 mm.

Preferably, the flexible package has a laminated film structure comprising multiple layers selected from the group consisting of a nylon layer, a polyethylene layer such as linear low-density polyethylene (L-LDPE) or low-density polyethylene (LDPE), a polyethylene terephthalate layer, a layer made of plastic on which an aluminum vapor deposition layer is formed, and an aluminum layer, and combinations thereof.

Preferably, the flexible package has a height ranging from 15 cm to 80 cm, preferably from 20 cm to 60 cm, more preferably from 30 cm to 50 cm; and a width ranging from 12 cm to 60 cm, preferably from 15 cm to 40 cm, more preferably from 20 cm to 40 cm. The flexible package has a bottom end which is foldable. When the flexible packaged is filled in perfumed particles, the bottom end is unfolded/flattened to a maximum thickness (maximum distance between front wall to back wall) of less than 12 cm.

Preferably, each of said particle in the packaged laundry product comprises:
(a) from 40% to 90% by weight of water-soluble carrier, wherein the carrier comprises materials selected from polyethylene glycol, polysaccharide, inorganic salts, and any combinations thereof,
(b) from 2% to 12% by weight of free perfume,
(c) from 2% to 20% by weight of friable perfume microcapsule, wherein said friable perfume microcapsule comprises encapsulated perfume, and
(d) from 0% to 20% of one or more detersive actives selected from the group consisting of surfactants, builders, bleach actives, enzymes, polymers, chelants, softeners, suds suppressors, suds boosters, brighteners, dye transfer inhibitors, and any combinations thereof.

Preferably, the flexible package is characterized by: (1) a height ranging from 15 cm to 80 cm, preferably from 20 cm to 60 cm, more preferably from 30 cm to 50 cm; and (2) a width ranging from 12 cm to 60 cm, preferably from 15 cm to 40 cm, more preferably from 20 cm to 40 cm.

Preferably, each of said particles is characterized by (1) a mass of from 2 mg to 500 mg, preferably from 5 mg to 300 mg; and/or (b) a maximum dimension ranging from 2 mm to 10 mm, preferably from 3 mm to 9 mm, more preferably from 4 mm to 8 mm; and/or (c) a substantially flat base and a height measured orthogonal to said base and together said particles have a distribution of heights, wherein said distribution of heights has a mean height between about 1 mm and about 5 mm and a height standard deviation less than about 0.3.

The packaged laundry product of the present invention provides perfume-containing particles filled into a flexible package which is transparent/translucent at least one or more parts on the wall. Through the transparent part of the flexible package, the consumer is easy to recognize desired products and have a delightful vision on the product from the first moment on shopping. The flexible package for the packaged laundry product of the present invention also comprises one or more holes in the bottom end with desired small size so that the perfume in the perfumed particles can evaporate and delight the consumer with scent when they come near to the package. Such unique innovation is particularly suitable for the perfumed beads product which retains in the package stably. Surprisingly, the one or more holes on the package can help reduce possibility of delamination of the flexible package caused by evaporation of perfume.

An advantage of the present invention is to provide a package having flexibility while maintaining rigidity needed to maintain form during dispensing and use of the product.

Another advantage of the present invention is that the transparent window showing solid particle of one or multiple colors enable easier of identification and use of product.

Another advantage of the present invention is that the package having transparent window and holes enables release of minimum amount of volatile materials so as to allow consumer to experience a small amount of freshness while laundry products are stored, enables better selection of laundry product at shelf, reducing risk of obtaining a product that is not pleasing in scent to the consumer.

Still another advantage of the present invention is that the transparent pouch enables consumers to view the fill level in the pouch ensuring product is only repurchased when needed.

Still another advantage of the present invention is that the transparent pouch may ensure product is completely dispensed before disposal thus ensuring no additional chemicals are disposed as waste material.

### BRIEF DESCRIPTION OF THE DRAWING

FIG. 1 is a perspective view of an embodiment of a flexible package of the present invention, where the reference “A” means the transparent parts on the flexible package.

### DETAILED DESCRIPTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “flexible”, when referring to a flexible package, refers to an easily deformable packaging material that cannot retain a fixed shape or stand on its own at room temperature and atmospheric pressure.

The term “rigid” refers to a material that is not easily deformable and can retain a fixed shape or stand on its own at room temperature and atmospheric pressure.

The term “detergent granule” refers to a particle comprising one or more detersive actives, such as surfactants, builders, bleach actives, enzymes, polymers, chelants, softeners, suds suppressors, suds boosters, brighteners, dye transfer inhibitors, and the like. Preferably, such detergent granules contain a sufficiently high level of fatty acids or salts thereof, e.g., at least 5% and preferably at least 7%. Such detergent granules may further contain one or more non-soap surfactants, such as an anionic surfactant and/or a nonionic surfactant.

The term “additive particle” refers to a particle comprising one or more detersive additives, such as perfumes, enzymes, bleaches, and the like.

The term “perfume-containing particle” or “perfumed particle” or “scent additive particle” refers to a particle comprising one or more perfume ingredients, such as free perfumes, pro-perfumes, encapsulated perfumes (including perfume microcapsules), and the like. Preferably, such perfume-containing particles contain perfumes encapsulated in perfume microcapsules, especially friable perfume microcapsules.

The term “consisting essentially of” means that the composition contains less than about 1%, preferably less than about 0.5%, of ingredients other than those listed.

Further, the term “substantially free of” or “substantially free from” means that the indicated material is present in the amount of from 0 wt % to about 1 wt %, preferably from 0 wt % to about 0.5 wt %, more preferably from 0 wt % to about 0.2 wt %. The term “essentially free of” means that the indicated material is present in the amount of from 0 wt % to about 0.1 wt %, preferably from 0 wt % to about 0.01 wt %, more preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Flexible Package

The flexible package of the present invention is preferably formed by at least one flexible film material having a flexibility factor within the range of 1,000-2,500,000 N/m. Flexible film materials can be configured to have a flexibility factor of 1,000-2,500,000 N/m, or any integer value for flexibility factor from 1,000-2,500,000 N/m, or within any range formed by any of these values, such as 1,000-1,500,000 N/m, 1,500-1,000,000 N/m, 2,500-800,000 N/m, 5,000-700,000 N/m, 10,000-600,000 N/m, 15,000-500,000 N/m, 20,000-400,000 N/m, 25,000-300,000 N/m, 30,000-200,000 N/m, 35,000-100,000 N/m, 40,000-90,000 N/m, or 45,000-85,000 N/m, etc.

The flexible film material may be made from plastic, paper, or a combination thereof. Preferably, the film is made from a plastic selected from the group consisting of polyethylene (PE), polyethylene terephthalate (PET), oriented polypropylene (OPP), biaxially oriented polypropylene (BOPP), and a combination thereof. The PE herein is selected from the group consisting of high-density polyethylene (HDPE), medium density polyethylene (MDPE), low density polyethylene (LDPE), linear low density polyethylene (LLDPE), metallocene polyethylene (mPE), biaxially oriented polyethylene (BOPE), and a combination thereof.

The flexible package of the present invention may be made from a multi-layer or a single-layer film, preferably a multi-layer film. Preferably, the multi-layer film comprises an outer layer and an inner layer. In a preferred embodiment, the multi-layer film is a two-layer film comprising an outer layer and an inner layer. The inner layer makes contact with the perfumed particles contained in the flexible package, whereas the outer layer forms the outermost surface of the flexible package. The outer layer and the inner layer may be independently selected from nylon, PE, PET, OPP, or BOPP. More preferably, the two-layer film is a PET/PE film wherein the PET acts as the outer layer, BOPP/PE film wherein the BOPP acts as the outer layer, or PE/PE film, even more preferably the two-layer film is a PE/PE film. In another embodiment, the multi-layer film is a three-layer film, preferably the middle layer of the three-layer film is BOPE. In yet another embodiment, the multi-layer film comprises at least one foamed thin layer which comprises bubbles, void volume, or cells.

The flexible package may have a top end, an opposing bottom end, and two peripheral walls extending between the top end and the bottom end. The two peripheral walls comprise a front wall and a back wall. The front wall is facing outwards when standing on the shelf. The front wall and the back wall and the bottom end can be made by different film material or the same film material.

Part, parts, or all of the flexible film material can be coated or uncoated, treated or untreated, processed or unprocessed, in any manner known in the art. The flexible film materials used to make the packages disclosed herein can be formed in any manner known in the art and can be joined together using any kind of joining or sealing method known in the art, including, for example, heat sealing (e.g., conductive sealing, impulse sealing, ultrasonic sealing, etc.), welding, crimping, bonding, adhering, and the like, and combinations of any of these.

In the present invention, part, parts or all of the flexible package is transparent or translucent. Preferably, the flexible package comprises a part or parts of the front wall is transparent or translucent. Preferably, the transparent part of the flexible package has a light transmission rate of more than 60%.

Preferably, the transparent part is present in the front wall of the flexible package and is in the range of 5% to 95% of the total area of the front wall of the flexible package.

Preferably, the flexible package has one or more holes on the bottom end. It allows the perfume evaporates out of the package thus the use can identify the scent before opening it, e.g. on the shelf. Each of the one or more holes has a maximum dimension of less than 2 mm, preferably less than 1 mm, more preferably less than 0.9 mm. The size of the one or more holes is much smaller than the size of the perfumed particle contained in the flexible package, thus no leaking risk.

A rigid spout is located at or near the top end of the flexible package. Such spout is in communication with the interior volume of the flexible package and is configured to dispense the particulate laundry detergent composition from within the flexible package. Preferably, the spout is positioned at a corner of the top end and one of the peripheral walls of the flexible package, to enable dispensing of the particulate laundry detergent composition at a slanted angle through such corner.

Preferably, the spout is cylindrical or substantially cylindrical, which defines an opening that is either circular or oval in shape. Preferably, the spout has a diameter ranging from about 20 mm to about 30 mm, preferably from about 21 mm to about 28 mm, more preferably from about 22 mm to about 26 mm. The desired volumetric flow rate for dispensing particulate laundry detergent product in general is from about 50 ml/sec to about 100 ml/sec, as measured according to Test 2 hereinafter. It has been discovered that rigid spouts with diameters within the above-mentioned range are particularly suitable for dispensing soap powder products of limited flowability. If the spout diameter is below 20 mm, e.g., around 15 mm, the volumetric flow rate for dispensing soap power is only about 25 ml/sec, which is too slow and may lead to under-dosing. If the spout diameter is above 30 mm, e.g., around 33 mm, the volumetric flow rate for dispensing soap power is above 164 ml/sec, which is too fast and may cause over-dosing. The spout may have a height ranging from about 20 mm to about 50 mm, preferably from about 30 mm to about 40 mm, more preferably from about 32 mm to about 38 mm.

The flexible package further comprises a cap that is removably engaged to the rigid spout, e.g., via inner threads that engage with corresponding outer threads on such rigid spout, to close the spout opening and prevent inadvertent leakage of the particulate laundry detergent product. The flexible package of the present invention may further comprise a rigid shoulder that flanks the base of the spout on both sides. Such a rigid shoulder may help to provide structural support near the base of the spout and enable unobstructed dispensing of the particulate laundry detergent composition.

The spout, cap, and shoulder as mentioned hereinabove are relatively rigid structures (in comparison with the flexible film that forms the flexible package itself) and can be made of any suitable rigid material, such as glass, metal, polymer, and the like, but preferably is made of polymer. In particular, the spout, cap, and shoulder can be made of the same or different materials. Preferably, each of them is independently made of a polymeric material selected from the group consisting of polypropylene (PP), polyethylene (PE), polycarbonate (PC), polyamides (PA) polyethylene terephthalate (PET), polyvinylchloride (PVC), polystyrene (PS), and a combination thereof.

The flexible package of the present invention may further comprise one or more handles located at or near the top end or along a peripheral wall of such package. Such handles can be through handles (i.e., a completely open space through which fingers and/or thumb can be inserted) that are formed by sealing one or more sections of the flexible package and then cut/puncture through such sealed sections.

### Perfume-Containing Particles

The perfume-containing particles contained in the flexible package in the present invention may each have a specific shape and size. Each of the perfume-containing particles has a mass of from 1 mg to 1 g and a maximum dimension of from 3 mm to 10 mm.

Preferably, the mass of each perfume-containing particle may be from about 2 mg to about 500 mg, preferably from about 5 mg to about 300 mg, more preferably from about 10 mg to about 200 mg, still more preferably from about 20 mg to about 125 mg, with alternative combinations thereof and any whole numbers or ranges of whole numbers of mg within any of the aforementioned ranges.

The perfume-containing particles of the present invention may have any shape selected from the group consisting of spherical, hemispherical, compressed hemispherical, cylindrical, disc, circular, lentil-shaped, oblong, cubical, rectangular, star-shaped, flower-shaped, and any combinations thereof. Lentil-shaped refers to the shape of a lentil bean. Preferably, the perfume-containing particles of the present invention have a hemispherical or compressed hemispherical shape. Compressed hemispherical refers to a shape corresponding to a hemisphere that is at least partially flattened such that the curvature of the curved surface is less, on average, than the curvature of a hemisphere having the same radius.

The perfume-containing particles of the present invention may each have a maximum dimension of from about 2 mm to 10 mm, preferably from about 3 mm to about 9 mm, more preferably from about 4 mm to about 8 mm. the particle may have a substantially flat base and a height measured orthogonal to said base and together said particles have a distribution of heights, wherein said distribution of heights has a mean height between about 1 mm and about 5 mm and a height standard deviation less than about 0.3.

The particle can have a shape of compressed hemispherical having an aspect ratio (i.e., the ratio of its base diameter over its height that is orthogonal to the base) of from about 2.0 to about 5, alternatively from about 2.1 to about 4.5, alternatively from about 2.2 to about 4. Oblong-shaped particle refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2.

An individual perfume-containing particle may have a volume from about 0.003 cm³ to about 0.15 cm³, preferably from about 0.005 cm³ to about 0.12 cm³.

In a preferred but not necessary embodiment of the present invention, perfume-containing particles of the present invention have a density lower than water, so that they can float on water. For example, such perfume-containing particles may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

A plurality of perfume-containing particles of the present invention can have different shapes, sizes, mass, and/or density.

The perfume-containing particles made by the method of the present invention may comprise: a perfume ingredient; polyethylene glycol; water-soluble or water-dispersible second carrier particles characterized by a specific particle size distribution; and optionally one or more adjunct ingredients, as described in detail hereinafter.

### Perfume Ingredients

The perfume-containing particles of the present invention may comprise from about 0.1 wt % to about 20 wt %, preferably from about 0.5 wt % to about 15 wt %, more preferably from about 1 wt % to about 10 wt % of one or more perfume ingredients, such as free perfumes, pro-perfumes, encapsulated perfumes (including perfume microcapsules), and the like.

In one embodiment, the perfume-containing particles comprise free perfumes and are substantially or essentially free of encapsulated perfumes. In such an embodiment, each perfume-containing particle may comprise no more than about 25%, preferably no more than about 20% (e.g., from about 0.1% to about 20%), more preferably from about 0.5% to about 15%, most preferably from about 1% to about 10%; alternatively, from about 9% to about 20%; alternatively, from about 10% to about 18%; alternatively, from about 11% to about 13%, alternatively, combinations thereof, of free perfumes by weight of such particle.

In another embodiment, the perfume-containing particles each comprise encapsulated perfumes (i.e., perfumes carried by a carrier material such as starch, cyclodextrin, silica, zeolites or clay or in form of perfume microcapsules), but are substantially or essentially free of free perfumes. Preferably, the perfume-containing particles comprise perfume oil encapsulated in perfume microcapsules (PMCs), which are preferably friable (verses, for example, moisture activated PMCs) but can also be moisture activated. For purposes of the present invention, the term “perfume microcapsules” or “PMC” describes both perfume microcapsules and perfume nanocapsules. In such an embodiment, each perfume-containing particle may each comprise from about 0.1% to 20%, preferably from about 0.5% to about 10%, more preferably from about 1% to about 5%, alternatively from about 4% to about 7%, alternatively from about 5% to about 7%, alternatively combinations thereof, of perfume microcapsules (preferably friable perfume microcapsules) by weight of the particles.

In yet another embodiment, each of the perfume-containing particles comprises both free perfumes and encapsulated perfumes (preferably in form of perfume microcapsules, and more preferably in form of friable perfume microcapsules), e.g., at a weight ratio ranging from about 1:5 to about 5:1, alternatively from about 1:4 to about 4:1, further alternatively from about 1:3 to about 3:1. In another embodiment, the perfume-containing particles may comprise from about 1% to about 10%, alternatively from about 2% to about 12%, alternatively from about 2% to about 8%, alternatively from about 3% to about 8%, alternatively from about 4% to about 7%, alternatively from about 5% to about 7%, alternatively combinations thereof, of PMCs by weight of the particles. In this embodiment, the perfume encapsulated by the PMC may comprise from about 0.6% to about 4% of perfume by weight of the particles.

In one embodiment, the PMCs comprise melamine/formaldehyde shells, which are commercially available from Appleton, Quest International, International Flavor & Fragrances, or other suitable sources. In a preferred embodiment, the shells of the PMCs are coated with polymer to enhance the ability of the PMCs to adhere to fabric.

In yet still another embodiment, the perfume-containing particles may comprise a formaldehyde scavenger. In yet still another embodiment, the scent of the perfume-containing particles is coordinated with scent(s) of other fabric care products (e.g., laundry detergent, fabric softener). This way, consumers who like APRIL FRESH scent, may use a packaged composition containing a plurality of perfume-containing particles having an APRIL FRESH scent, thereby coordinating the scent experience of washing their laundry with their scent experience from using APRIL FRESH. The perfume-containing particles of the present invention may be sold as a product array (with laundry detergent and/or fabric softener) having coordinated scents.

### Carriers

The perfume-containing particles of the present invention comprise from about 5% to about 99% of a carrier. The carrier in the perfume-containing particles may comprise water-soluble and hot-meltable material, preferably having melting point from 35° C. to 70° C. The carrier can be materials selected from polyethylene glycol, polypropethylene glycol, ethylene oxide/propylene oxide block copolymers, nonionic surfactant, and combinations thereof. For example, the carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

Preferably, each of the perfume-containing particles comprises from about 5 wt % to about 90 wt %, preferably from about 10 wt % to about 70 wt %, more preferably from about 20 wt % to about 60 wt % of PEG, and more preferably such PEG is characterized by a weight average molecular weight (Mw) ranging from about 2,000 to about 30,000 Daltons, preferably from about 3,000 to about 20,000 Daltons, more preferably from about 4,000 to about 15,000 Daltons. Suitable PEGs include homopolymers commercially available from BASF under the tradenames of Pluriol® E 8000.

A particularly preferred PEG within the meaning of the present invention is an ethylene oxide-propylene oxide-ethylene oxide (EOₓ₁POyEOₓ₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOₓ₁POyEOₓ₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOₓ₁POyEOₓ₂) triblock copolymer improve cleaning.

Suitable ethylene oxide-propylene oxide-ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

In the present invention, the carrier can further be or comprise a water-soluble material selected from the group consisting of water-soluble inorganic alkali metal salt, water-soluble alkaline earth metal salt, water-soluble organic alkali metal salt, water-soluble organic alkaline earth metal salt, water soluble carbohydrate, water-soluble silicate, water soluble urea, and any combination thereof. Preferably, the carrier could be selected from the group consisting of sodium chloride, sodium sulfate, sodium carbonate, sodium bicarbonate, sodium citrate, magnesium chloride, magnesium sulfate, potassium chloride, potassium sulfate, potassium carbonate, potassium bicarbonate, calcium bicarbonate, zeolite, silica, clay, and combinations thereof,

The carrier can further be or comprises polysaccharide, for example selected from starch, cellulose, or derivatives thereof.

### Optional/Adjunct Ingredients

The perfume-containing particles of the present invention may optionally comprise one or more optional/adjunct ingredients, including colorants, solvents, softening actives, and combinations thereof, in an amount ranging from about 0.01 wt % to about 10 wt %, preferably from about 0.02 wt % to about 8 wt %, more preferably from about 0.1 wt % to about 5 wt %.

The colorants may impart to the perfume-containing particles a color selected from the group consisting of blue, green, yellow, orange, pink, red, purple, grey, and the like. The colorants may be selected from the group consisting of dyes, pigments, and combinations thereof. Preferably, the colorants include at least one dye selected from those typically used in laundry detergent or fabric softeners. Examples of suitable dyes include, but are not limited to, LIQUITINT BLUE BL, LIQUITINT PINK AM, AQUA AS CYAN 15, and VIOLET FL, available from Milliken Chemical. If a dye is employed, the perfume-containing particles may comprise less than about 0.1%, alternatively about 0.001% to about 0.1%, alternatively about 0.01% to about 0.02%, alternatively combinations thereof of such dye by weight of the particles.

The perfume-containing particles of the present invention may be substantially free of laundry active and/or fabric softener actives. To reduce costs and avoid formulation capability issues, one aspect of the invention may include perfume-containing particles that are essentially free or completely free of laundry actives and/or fabric softener actives. In one embodiment, each of the perfume-containing particles comprises less than about 3%, alternatively less than about 2%, alternatively less than about 1%, alternatively less than about 0.1% by weight of the perfume-containing particles, of laundry actives and/or fabric softener actives (or combinations thereof). Laundry actives may include: detergent surfactants, detergent builders, bleaching agents, enzymes, polymers, chelants, softeners, suds suppressors, suds boosters, brighteners, dye transfer inhibitors, and the like. It is particularly preferred that the perfume particles of the present invention are substantially free of or essentially free of surfactants, because the presence of such surfactants may speed up dissolution of the perfume particles in water, which is undesirable in the context of the present invention. It is appreciated that a non-detersive level of surfactant may be used to help solubilize perfume contained in the composition. More preferably, the perfume particles of the present invention are substantially free of or essentially free of any detersive actives.

Depending on the application, the perfume-containing particles of the present invention may comprise a solvent selected from the group consisting of glycerin, polypropylene glycol, isopropyl myristate, dipropylene glycol, 1,2-propanediol, and PEG having a weight average molecular weight less than 2,000, and mixtures thereof.

The perfume-containing particles can further comprise an antioxidant. The antioxidant can help to promote stability of the color and or odor of the particles over time between production and use. The perfume-containing particles can comprise between about 0.001% to about 2%, preferably between 0.01% to about 1%, more preferably between about 0.05% to about 0.5% by weight of such antioxidant. The antioxidant can be butylated hydroxytoluene.

### Test Method and Examples

### Test 1: Light Transmission Rate

Light Transmission rate can be used to test the transparency of the flexible package. The higher transmission rate is, the higher transparency level is. For example, the flexible package of the present invention shows a transmission rate above 60%.

### Test 2: Package Product Compatibility Test (PPCT)

PPCT is a test for measuring the stability of a package product and conducted by package observation after storage with product at 40 degree C. 75% RH, test for 3 months.

### Test 3: Plastic Film Stiffness Test

Plastic film Stiffness test can be conducted to test a bending stiffness of a package. For different film, use the Instron to add the compressive loading to the arched film. Record the squeeze of the different film to compare the stiffness performance.

### EXAMPLES

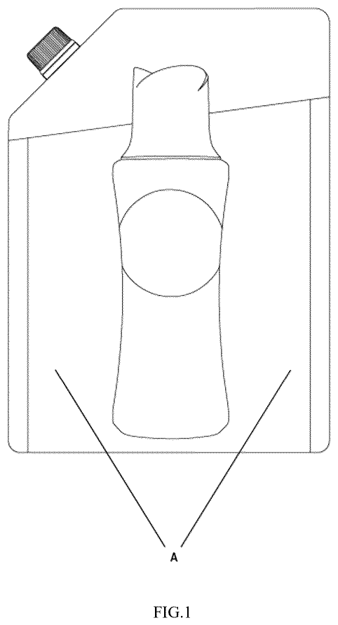

FIG. 1 shows an example of the flexible package in a folded state, before filling the perfumed particle. It has a top end and bottom end and a front wall and a back wall, where the bottom end is foldable in between of the front wall and the back wall. It has a spout on the top end at one side. There are two parts of transparent space (referenced as “A” in the FIG. 1) on the front wall. The bottle shape on the package is an artwork printed on the front wall which area is not transparent.

Examples 1 and 2 are packaged products containing perfume beads filled in an opaque pouch, the pouch has a size of 310 mm×210 mm×50 mm. Example 2 has eight (8) venting holes on the bottom end of the pouch, while Example 1 has not. The beads filled in the Examples 1 and 2 are commercially available Beads (Downy laundry scent beads).

Examples 3 and 4 are packaged products containing perfume beads filled in a transparent pouch as shown in FIG. 1, which has transparent area on the front wall. Pouch size is 310 mm×210 mm×50 mm. Inventive Example 4 has eight (8) venting holes on the bottom end of the flexible package, while Example 3 has not. The beads filled in the Examples 3 and 4 are commercially available Beads (Downy laundry scent beads).

A panel of 5 people (ages between 20 to 45 years old) are asked to rate the 4 examples based on appearance and aroma. The rating score is 1 to 5, the higher the score, the higher the level of preference. The results are shown in Table 1 below.

TABLE 1

| | Example | | | |
|---|---|---|---|---|
| | 1 | 2 | 3 | 4 |
| | Opaque | Opaque | Transparent | Transparent |
| | pouch | pouch | pouch | pouch |
| scores | without holes | with holes | without holes | with holes |
| Panel 1 | 3 | 3 | 4 | 5 |
| Panel 2 | 1 | 3 | 3 | 5 |
| Panel 3 | 2 | 3 | 4 | 5 |
| Panel 4 | 2 | 4 | 3 | 5 |
| Panel 5 | 2 | 3 | 4 | 5 |
| Avg. | 2 | 3.2 | 3.6 | 5 |

The results show that the transparent packaging with holes has the highest score and is the most favored, while opaque packaging without holes has the lowest score.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged laundry product comprising a flexible package and a plurality of perfume-containing particles contained in the flexible package,
wherein each of the perfume-containing particles comprises:
a carrier; and
a perfume;
wherein each of said particles has a mass between 1 mg to 1 g; and
wherein each of said particles has a maximum dimension of less than 10 mm,
wherein the flexible package is made of a layered film material, and comprises a top end, an opposing bottom end, and two peripheral walls extending between the top end and the bottom end,
characterized in that at least one or more parts of the flexible package is transparent or translucent, and
characterized in that the bottom end of the flexible package comprises one or more holes.

2. The packaged laundry product according to claim 1, wherein the at least one or more parts of the walls of the flexible package is transparent, preferably the transparent part(s) has a light transmission rate of more than 60%.

3. The packaged laundry product according to claim 1, wherein the transparent part is present in the front wall of the flexible package and is in the range of 5% to 95% of the total area of the front wall of the flexible package.

4. The packaged laundry product according to claim 1, wherein each of the one or more holes has a maximum dimension of less than 2 mm.

5. The packaged laundry product according to claim 1, wherein each of the one or more holes has a maximum dimension of less than 1 mm.

6. The packaged laundry product according to claim 1, wherein the flexible package further comprises a solid spout located at or near the top end of the flexible package.

7. The packaged laundry product according to claim 6, wherein the flexible package has a diameter ranging from 20 mm to 30 mm, and the rigid spout is further characterized by a height ranging from 20 mm to 50 mm.

8. The packaged laundry product according to claim 6, wherein the flexible package has a diameter ranging from 21 mm to 28 mm, and the rigid spout is further characterized by a height ranging from 30 mm to 40 mm.

9. The packaged laundry product according to claim 1, wherein the flexible package has a laminated film structure comprising multiple layers selected from the group consisting of a nylon layer, a polyethylene layer such as linear low-density polyethylene (L-LDPE) or low-density polyethylene (LDPE), a polyethylene terephthalate layer, a layer made of plastic on which an aluminum vapor deposition layer is formed, an aluminum layer, and combinations thereof.

10. The packaged laundry product according to claim 1, wherein the flexible package characterized by: (1) a height ranging from 15 cm to 80 cm; and (2) a width ranging from 12 cm to 60 cm.

11. The packaged laundry product according to claim 1, wherein the flexible package characterized by: (1) a height ranging from 20 cm to 60 cm; and (2) a width ranging from 15 cm to 40 cm.

12. The packaged laundry product according to claim 1, wherein each of said particle comprises:
(a) from 40% to 90% by weight of water-soluble carrier, wherein the carrier comprises materials selected from polyethylene glycol, polysaccharide, inorganic salts, and any combinations thereof,
(b) from 2% to 12% by weight of free perfume,
(c) from 2% to 20% by weight of friable perfume microcapsule, wherein said friable perfume microcapsule comprises encapsulated perfume, and
(d) from 0% to 20% of one or more detersive actives selected from the group consisting of surfactants, builders, bleach actives, enzymes, polymers, chelants, softeners, suds suppressors, suds boosters, brighteners, dye transfer inhibitors, and any combinations thereof.

13. The packaged laundry product according to claim 1, wherein each of said particle is characterized by a mass of from 2 mg to 500 mg.

14. The packaged laundry product according to claim 1, wherein each of said particle is characterized by a maximum dimension ranging from 2 mm to 10 mm.

15. The packaged laundry product according to claim 1, wherein each of said particle is characterized by a substantially flat base and a height measured orthogonal to said base and together said particles have a distribution of heights, wherein said distribution of heights has a mean height between about 1 mm and about 5 mm and a height standard deviation less than about 0.3.

16. The packaged laundry product according to claim 1, wherein each of said particle is characterized by a mass of from 2 mg to 500 mg; and a maximum dimension ranging from 2 mm to 10 mm.

17. The packaged laundry product according to claim 1, wherein each of said particle is characterized by a mass of from 2 mg to 500 mg; and a substantially flat base and a height measured orthogonal to said base and together said particles have a distribution of heights, wherein said distribution of heights has a mean height between about 1 mm and about 5 mm and a height standard deviation less than about 0.3.

18. The packaged laundry product according to claim 1, wherein each of said particle is characterized by a maximum dimension ranging from 2 mm to 10 mm; and a substantially flat base and a height measured orthogonal to said base and together said particles have a distribution of heights, wherein said distribution of heights has a mean height between about 1 mm and about 5 mm and a height standard deviation less than about 0.3.

19. The packaged laundry product according to claim 1, wherein each of said particle is characterized by (a) a mass of from 2 mg to 500 mg; and (b) a maximum dimension ranging from 2 mm to 10 mm; and (c) a substantially flat base and a height measured orthogonal to said base and together said particles have a distribution of heights, wherein said distribution of heights has a mean height between about 1 mm and about 5 mm and a height standard deviation less than about 0.3.

20. The packaged laundry product according to claim 1, wherein each of said particle is characterized by (a) a mass of from 5 mg to 300 mg; and (b) a maximum dimension ranging from 4 mm to 8 mm; and (c) a substantially flat base and a height measured orthogonal to said base and together said particles have a distribution of heights, wherein said distribution of heights has a mean height between about 1 mm and about 5 mm and a height standard deviation less than about 0.3.
